(19) United States
(12) Patent Application Publication
(10) Pub. No.: US 2025/0003405 A1
(43) Pub. Date: Jan. 2, 2025

(54) Stator for a Pump and Method for Producing a Stator for a Pump

(71) Applicant: NETZSCH Pumpen & Systeme GmbH, Selb (DE)

(72) Inventors: Mikael Tekneyan, Kraiburg am Inn (DE); Franz Lachenwitzer, Waldkraiburg (DE); Priscilla Benedet-Eulenberger, Feldkirchen (DE); Hisham Kamal, Waldkraiburg (DE)

(21) Appl. No.: 18/749,874

(22) Filed: Jun. 21, 2024

(30) Foreign Application Priority Data
Jun. 27, 2023 (DE) 10 2023 116 836.3

(51) Int. Cl. F04C 2/16; B33Y 80/00; F04C 2/12

(52) U.S. Cl. CPC F04C 2/16; F04C 2/126; B33Y 80/00; F04C 2230/22; F04C 2240/10

(57) ABSTRACT

A stator for a pump, in particular for a rotary piston pump or an eccentric screw pump, having a base body, wherein the base body surrounds a pumping area for a rotor arrangement of the pump, includes a support body and a running body, and the running body configures a running surface for at least partial contact with the rotor arrangement of the pump, wherein the support body and the running body includes a common material and wherein a material density of the material of the support body and a material density of the material of the running body are configured differently from one another, so that a different elasticity and/or a different hardness of the material is achieved in the support body and in the running body by means of the differently configured material densities. Furthermore, the invention relates to a method for producing such a stator.

### TECHNICAL FIELD

The invention relates to a stator for a pump, in particular for a rotary piston pump or an eccentric screw pump, having a base body such that the base body surrounds a pumping area for a rotor arrangement of the pump, configures a support body and a running body, and the running body configures a running surface for at least partial contact with the rotor arrangement of the pump. In addition the invention relates to a method for producing a stator for a pump as well as a stator for a pump, produced by means of such a method.

### BACKGROUND

Known stators, for instance for eccentric screw pumps, are sometimes equipped with elastomers, for example with a coating configured by an elastomer, in order to ensure good elastic properties during the pump's operation in comparison with a rotor running in the stator. Alternatively, stators are also known in the art which are constructed as solid-material stators, for instance of metallic construction, which demonstrate good wearing properties during operation, although they impose considerable demands on manufacturing precision, demonstrate comparably low pumping capacity or, for example, fail to insulate completely.

Concerning a cross-section and/or lengthwise extension of the elastic material of such a stator, corresponding stiffness, elasticity and/or hardness inside the stator is identical in each case and, for example, depends only on a thickness and/or on specific properties of a selected elastomer.

### SUMMARY

It is the object of the invention to improve the present state of the art.

This object is fulfilled by means of a stator for a pump, in particular for a rotary piston pump or an eccentric screw pump, having a base body such that the base body surrounds a pumping area for a rotor arrangement of the pump, configures a support body and a running body and such that the running body configures a running surface for at least partial contact with the rotor arrangement of the pump, wherein the support body and the running body comprise a common material and the density of one material of the support body and the density of one material of the running body are employed in ways differing from one another, so that a different elasticity and/or a different hardness of the material in the support body and in the running body is achieved by means of the differently configured material densities.

With this configuration of a stator, the common material can be used for the entire stator or for large parts of the stator and nevertheless a structural distinction between running body and support body can be achieved in such a way that the running body and the support body each comprise different properties, which are relevant in the operation of the pump.

In this manner, properties can be imprinted on the running body, for instance, with the intention of achieving a particular resistance to wear, while properties can be imposed on the support body which, for instance, instill high elasticity and resilience with respect to mechanical impacts.

The following terms are relevant in this context:

A “pump” is a technical device which conveys a fluid by means of a motion, in particular by means of a relative motion of mechanical components with respect to one another. In particular, in the context of the present invention such a pump is a so-called displacement pump. Such a displacement pump advances the fluid, in particular by means of a local displacement of the fluid, and is, for example, constructed as a rotary piston pump or an eccentric screw pump.

A “stator” designates a fixed part of a pump, in relation to which a rotor, for example, is movably arranged. Such a stator is designed either to act entirely consonantly with the rotor of the pump, for example in a rotary piston pump, or to ensure elastic direct contact of the stator with a rotor or rotor arrangement of a pump during the rotor motion or eccentric rotor motion of the rotor, for example in an eccentric screw pump. Together, stator and rotor serve the function of the “pump,” that is, of a technical device for moving fluids, for example for pumping liquids, in that a volume inside the pump is dynamically moved by means of the interaction of stator and rotor.

A “base body” designates here the mechanical entirety of the stator, which provides its structural integrity and also corresponding functional surfaces. Such a base body of the stator here surrounds, for instance, a “pumping area” completely or even partly, provided the stator is arranged inside a pump. The pumping area serves to receive a rotor arrangement, that is, for example, to receive a rotor or several rotors, such that one rotor in this context can also be an eccentric screw axle of an eccentric screw pump. Likewise, the rotor or a corresponding rotor arrangement can also designate toothed wheels in a tooth-wheel pump, rotary pistons in a rotary piston pump or comparable technical devices in a correspondingly constructed pump. The key concept of the invention in this context is to equip at least one or two components, namely the stator and/or one or more corresponding rotors, with a common material and with different material densities in order to generate different technical properties. This is achieved, for example, by corresponding manufacturing processes.

A “support body” in this context designates, for example, a supporting structure or a portion of the base body, which essentially serves to mechanically carry forces and, for example, to receive shapings, whereas on the other hand a “running body” is intended particularly to act upon the rotor arrangement and to provide a “running surface” with respect to the rotor. It is of particular relevance here that the running body and the provided running surface, for example, comprise a higher degree of hardness than the support body or, for example, show adaptive gliding properties with respect to the rotor.

A “common material” in this context designates, in particular, a common basic material or a common starting material from which both the support body and the running body of the stator are configured. For example, an elastomer of a particular group or type can be selected as common material, as can a particular metal, for instance stainless steel. In addition, for example, a TPE, that is, a thermoplastic elastomer, can be employed for this purpose. Such a TPE comprises elastic properties of an elastomer and nevertheless, contrary to a classic elastomer, for instance a vulcanized elastomer, can be partly softened by effects of heating or melting, at least partly. Such TPEs at the same time are often recyclable as well and thus sustainable. It should be pointed out that the support body and/or the running body are made up of a common starting material and also after the manufacturing process comprise identical or comparable chemical properties; however, in their macroscopic or microscopic material density they are of different configuration. This difference in material density, in this case, does not constitute a distinction that would contradict a “common material.”

A “material density” of the respective body part of the base body designates in this context the arrangement of corresponding material parts in order to achieve different specific weights and/or different percentage material portions in a comparative volume, so that the material density can designate both a gravimetric density, for example in g/cm3, as well as a structural density, for example in vol.-%. This structural density can also be obtained, for example, by an uneven distribution of material and gaps within a defined volume.

“Differently configured” in this context indicates that a material density of the material of the support body is, for example, adjusted as lower or higher than a material density of the material of the running body, and thus for example the running body is less porous than the support body and/or has a higher specific weight.

“Elasticity” designates the capacity of the accordingly produced material to assume elastic reshaping, for example to cause a high elongation at breaking and/or a high capacity to absorb energy without permanently damaging the material. A “hardness” designates in this context the resistance of the material to local reshaping, for example when pressed, and/or to mechanical abrasion by wearing of the surface. A “hard” material here is, for example, more resistant to wear than a “soft” material. For elastomers, additional or alternative evaluation standards can also include, in particular, rebound resilience, which refers to the material's capacity to abandon an imposed reshaping after impact and to resume its original form. This property is particularly significant during a motion of the rotor in the stator, because a rapid, as complete as possible rebounding of the stator is relevant in maintaining a given density.

To configure the running body to be particularly resistant to wear with respect to the rotor, the material density of the running body is greater than the material density of the support body, so that the running body comprises, in particular, a lesser degree of elasticity and/or a greater hardness and/or an adjusted rebound elasticity than the support body.

In one embodiment, the support body comprises a first support body part, a second support body part, a third support body part and/or an additional support body part, whereby the material densities of the material of the respective support body part are configured from one another, so that a different elasticity and/or a different hardness of the material is achieved in the respective support body part with respect to the respective other support body part, by means of the differently configured material densities for example, wherein in particular the respective support body parts are arranged in layers situated essentially radially around the pumping area.

As a result of this configuration, the support body, for example, can be gradually changed mechanically, wherein here a boundary can occur between respective support body parts, even in a fluid manner, so that for example an elasticity spectrum and/or a hardness spectrum can be achieved, particularly radially to the pumping body. Likewise, corresponding support body parts can also be configured, however, in layers, sections or regions of the support body. Such “support body parts” here are different sections, regions or also partial areas of the support body that can be geometrically locatable.

It should be mentioned here that an adjusted material density can also be selected gradually or in stages along a longitudinal axis of the rotor of an eccentric screw pump in order to oppose the rising inner pressure in the pumping area that occurs on account of the construction principle of the eccentric screw pump. For example, for this purpose the hardness of the stator on an inlet side of the eccentric screw pump affected by a lower pressure is reduced and it is increased in the direction of an outlet side of the eccentric screw pump in order to counter the pressure rising successively along the conveying direction and to further ensure an insulation between stator and rotor.

The designation “radially around the pumping area” in this context describes an arrangement, for instance around a shaft of a rotor, that is, a corresponding rotary axis. It should be stated in this context that “radially” can in no case be interpreted with mathematical precision, but instead, for instance, includes technical aberrations, determined by the geometry of the rotor or other peripheral conditions. Thus locally “radial” arrangements around a pumping area in the case of a rotary piston pump can also designate corresponding partial areas of a pump with respect to a respective rotary piston.

For example, the support body and/or, in particular, the respective support body part comprise an inner structure wherein the inner structure comprises pores, cavities and/or chambers, as well as webs, lamellae and/or material bridges, wherein in particular a different elasticity, an adjusted spring effect and/or a different hardness or else different rebound elasticity of the material is achieved in the support body and in the running body, by means of the macroscopic material densities configured by the distribution of the pores, cavities and/or chambers as well as webs, lamellae and/or material bridges.

Such an “inner structure” here designates, for example, a geometrically determined or also a geometrically indeterminate arrangement of deliberately caused vacancies within the material, wherein as a result essentially round vacancies such as pores, geometrically larger “cavities” or even “chambers,” that is, conscious geometrically caused vacancies, can be introduced. Corresponding material areas, namely webs, lamellae and/or material bridges, determine in their emphasis corresponding mechanical properties. A “macroscopic material density” in this context designates, for instance, a material density observed over the entire support body and/or over the entire support body part, wherein local material densities accordingly differ by their nature, for instance owing to high material densities within the webs and low material densities within cavities, which can decline all the way to zero.

Thus the stator can be provided in places, for example, with spring elements or elastic support elements.

In particular, the inner structure here can be configured as accessible by fluid-conducting by means of a pressure fluid supply line or several pressure fluid supply lines, wherein, by means of introducing a pressure fluid through the pressure fluid supply line or through the pressure fluid supply lines into the pores, cavities and/or chambers of the inner structure, a pressure-induced force is increased and/or it can be reduced by diverting a pressure fluid through the pressure fluid supply line or through the pressure fluid supply lines out of the pores, cavities and/or chambers of the inner structure.

For example, the hardness and/or the flexibility of the stator can be adjusted according to need, even periodically or by sections, by adjusting a pressure and/or a volume of the pressure fluid in the inner structure. In particular, adjustment of the stator's properties can also occur along the conveying direction with pressure adjustment, so that with rising pressure in the pump along a conveying direction an adjusted counter-force of the stator on the rotor can also be adjusted.

“Pressure fluid supply” in this context is, for instance, a valve, a pressure connection or an opening, in particular with a unidirectional valve or with a controllable valve, which makes possible the supply of a fluid designated as “pressure fluid,” for instance of a gas or a liquid. Thus, by means of a correspondingly adjusted pressure in the inner structure, corresponding behavior of the stator can be brought about.

For this purpose an “input” takes place, that is, the supply of pressure fluid to increase or maintain pressure, or an “outlet,” the release of pressure fluid to reduce or maintain pressure, depending in each case, for example, on a reshaping of the stator by periodic action of the rotor.

In particular here, the addition or additions of pressure fluid is subject to a control device regulating the introduction or release of pressure fluid through the pressure supply line.

In this manner, for instance, it also becomes possible, in sections along the conveying direction, to adjust pressure of the pressure fluid and thereby a corresponding mechanical behavior of the stator.

A “control device” here can be, for instance, an electronic control that triggers a valve block, for instance to control or regulate the pressure depending on a pressure sensor.

In one embodiment, the support body and/or in particular the respective support body part and/or the running body is produced by means of a material-forming primary molding process, in particular by means of an additive process and/or by means of a sintering process.

In particular, material-forming primary molding processes here can generate, during manufacture of the stator, a corresponding distribution of material densities, for instance in the case of an additive process by generating a local production density of the material and/or by means of a sintering process by generating the base body through diverse granular output materials.

A “material-forming primary molding process” designates here a process in which the material is formed together with the work piece, such as from a basic material, a base mass or a powder or granulate, particularly by physical impact. Here, for example, a TPE granulate can be used for the aforementioned reasons. An “additive process” in this case is known, for example, as “3D printing,” that is, for instance, as a thermoplastic application method, as laser sintering process or the like. A “sintering process” designates a method conducted under pressure and at high temperature, primarily on the basis of metallic powders, wherein the material is compressed and connected together locally from individual particles, but without completely fusing the original material.

In particular here, the common material can comprise an additional material, wherein in particular the diverse material density is additionally modified, in addition by means of a respective portion of the additional material in the support body, in the respective support body part and/or in the running body.

Here, for example, an “additional material,” such as a filler material, an abrasive material and/or another material can be used to locally influence the material properties. Thus, for instance, a ceramic powder can be worked into the running body in order to connect high density of the running body with corresponding resistance to wear. Likewise, gliding particles such as graphite particles or TPFE particles (the TPFE material also being known as Teflon) can be added to reduce glide friction

In one embodiment the common material comprises a synthetic material, in particular an elastomer, a thermoplastic elastomer, a duroplast and/or a thermoplast and/or a metal, in particular a steel, aluminum and/or titanium.

In an additional aspect, the object of the invention is fulfilled by means of a process for producing a stator for a pump, in particular according to one of the previously designated embodiments, wherein the stator comprises a base body with a support body and a running body, the base body surrounds a pumping area for a rotor of the pump, and the running body configures a running surface for at least partial contact with the rotor of the pump, wherein the base body comprises a range of different material basic materials, with the following steps:

introducing a material basic material into a production space so that the material basic material is present in the production space,

treating the material basic material in the production space, wherein the material basic material is converted into a common material by means of the treatment and wherein the treatment is conducted differently for a first production area for producing the support body from the treatment for a second production area for producing the running body, in such a way that a material density of the material of the support body and a material density of the material of the running body are configured differently from one another,

so that the stator is manufactured in such a way that a different elasticity and/or a different hardness of the material in the supporting body and in the running body is achieved by means of the differently adjusted material densities.

“Introduction” of a material basic material into a production space, in this context, designates production of a “material basic material,” that is, of an output filament, for instance, for a 3D printer and/or of a sintering powder for a sintering process in a production space, wherein the production space can refer to a 3D printer, a sintering form or a comparable device.

“Treating” here designates the impact on the material basic material, for instance in the case of a 3D printer by means of heating and application of a filament or, for example, by means of an irradiation of a laser on a power or granulate, so that the material basic material is converted to common material, for instance by melting. Analogously, treatment in a sintering process can occur by means of applying pressure and/or heat.

As a result, a stator is created in the manner described, wherein in particular the support body and running body comprise different material densities.

In particular the treatment is conducted by means of a material-forming reshaping process, in particular by means of an additive method and/or by means of a sintering process. Here, particularly in a common manufacturing process, that is with production of the entire base body, respective manufacturing parameters are adjusted in such a way that different material densities are generated. For instance, local pressures, impacts of laser, temperature or geometrical arrangement of corresponding material areas are adjusted.

In an additional aspect, the object of the invention is fulfilled by means of a stator for a pump that is produced by means of such a method.

It should be mentioned in this context that in addition to the production of a stator according to the invention, a rotor of a pump is also covered in equivalent manner, to the extent, for example, that different properties of a material in a pump rotor are suitable for the special production of the pump in analogous manner to the indicated respective embodiments of a stator.

According to an additional aspect, the object is solved by means of a pump, in particular a rotary piston pump and/or an eccentric screw pump with a stator and/or rotor according to one of the aforementioned embodiments and/or wherein the stator and/or rotor is produced by means of a method as described above.

### BRIEF DESCRIPTION OF THE DRAWINGS

In addition, the invention is explained in greater detail with reference to the embodiments. The illustrations are as follows:

FIG. 1 shows a schematic sectional depiction of a rotary piston pump in a lateral view.

FIG. 2 shows a schematic sectional depiction of an eccentric screw pump in a lateral view.

FIG. 3 shows a schematic sectional depiction of a stator of the rotary piston pump of FIG. 1.

FIG. 4 shows a schematic sectional depiction of a stator of the eccentric screw pump of FIG. 2.

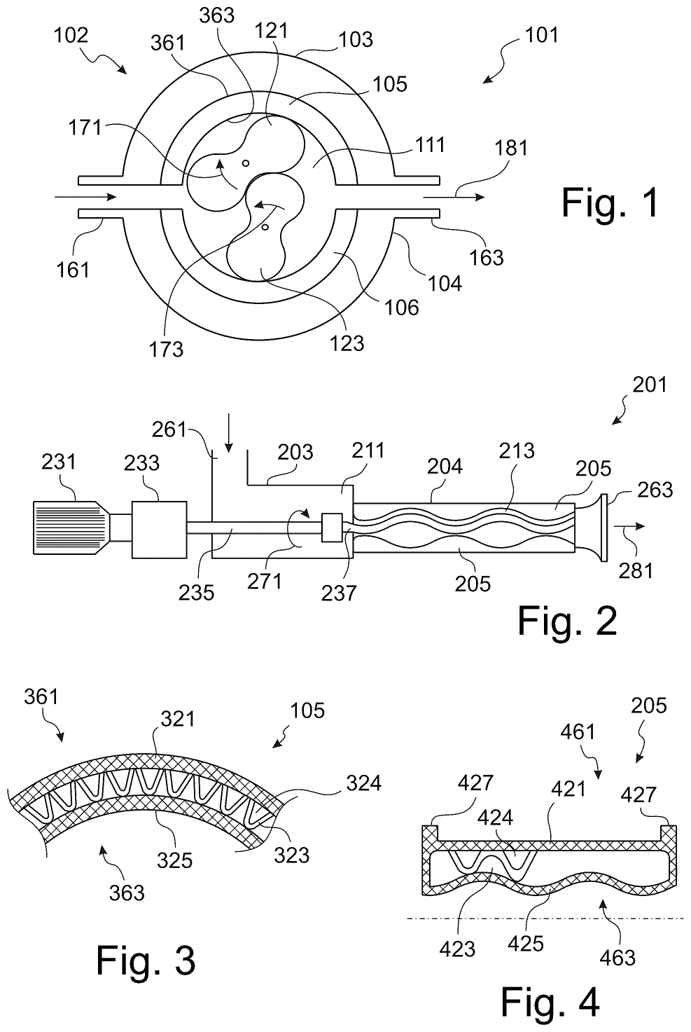

### DETAILED DESCRIPTION

A rotary piston pump 101 comprises a housing 102 having two housing parts 103 and 104. Bordered by a stator 105 in the housing part 103 and a stator 106 in the housing part 104 is an interior space 111 in which a rotary piston 121 as well as a rotary piston 123 are rotatably arranged along a respective rotary direction 171 and 173. The rotary pistons 121 and 123 are arranged to operate in contrary directions and serve, inside the oval housing 102, to pump fluids along a conveying direction 181. Corresponding fluid is supplied in a supply line 161, pumped by means of the rotary pistons 121 and 123 in the inner space 111, and discharged through an outlet 163.

The stator's interior layout is exemplified by the stator 105, which is identical to the structure of the stator 106.

It is significant here that, in relation to the respective rotary pistons 121 and 123, a hard surface serves the purpose of good resistance to wear, while on the other hand the base structure of the respective stator should be sufficiently elastic in construction to allow it to fit tightly with the respective rotary piston, so that the rotary piston pump is well insulated and thus has a high degree of efficiency.

The stator 105 comprises a support layer 321 facing the housing part 103, and a supporting structure 323 follows in the direction of the rotary piston 121 along with a running layer 325 facing the rotary piston 121. The stator is produced by means of a 3D printing method, wherein the support layer 321 has been produced with medium-level density and elasticity by means of this method. The supporting structure 323 comprises deliberately planned free spaces 324, generating a timber-style framework structure of high elasticity and increased resilience against reshaping. The running layer 325, on the other hand, is produced with high density and with aggregate material for increased resistance to wear, so that a running side 363 facing the rotary piston 121 is wear-resistant and a housing side 361 facing the housing part 103 is accordingly elastic and reshapable. It should be mentioned that the structure of the stator can be analogous to that of the rotary piston, wherein for this case the rotary piston is produced analogously to the stator previously described. Thus, in addition, the surface of the rotary piston can be constructed analogously to the stator 105 structure, that is, as an elastic structure produced by 3D printing, wherein the stator then is of stainless steel construction, for example. Axial insulation can thereby be improved, moreover, in that the rotary piston also axially has a corresponding elastic surface.

An eccentric screw pump 201 comprises a first housing part 203 as well as a pumping housing 204. Outside the housing part 203, a motor 231 is arranged, which powers a shaft 235 by means of a transmission 233. The shaft 235 in turn is form-locked with an eccentric screw 237. Here, alternatively, connection can be provided by means of a hinge. The eccentric screw 237 is mounted in the pump housing 204 and can rotate in a rotary direction 271 in an elastic stator 205. Both the eccentric screw 237 and the stator 205 are configured in circular meandering fashion, so that when the eccentric screw 237 rotates, fluid is pumped out of an inner space 211 in the housing part 203 through a pumping area 213 in the pump housing 204 along a conveying direction 281. As a result, a fluid can be absorbed through an intake 261 on the housing part 203 and pumped along the pumping area 213 to an outlet 263.

The stator 205 (see FIG. 4 for details) here is produced with different density throughout its volume as well as differences in structure, but is made of a common material. The stator 205 here is constructed of an elastomer.

The stator 205 comprises protrusions 427 on one housing side 461 for form-locking mounting in the pump housing 204, and on the housing side a support layer 221 with medium density is produced. In the direction of the eccentric screw 237, then, a supporting structure 423 analogous to the supporting structure 323 is disposed, wherein free spaces 424 are also provided here. Thus the supporting structure 423 is likewise of timber frame-like construction. A layer 425 facing the eccentric screw 237 on a running side 463 is constructed with high density and thus high resistance to wear.

The stator 204 is produced in a 3D printing process, whereby different densities of the respective layers and structures are produced by means of adjustment in the corresponding pressure parameters. In the area of the supporting structure 423, the timber-like structure is produced by omissions of material. It is relevant in this context that the stator 205 can comprise chambers (not illustrated) in its interior that are bordered from one another by the supporting structure 423, so that, for example, a number of chambers are arranged along the conveying direction 281 of the eccentric screw pump 201 and by means of a compressed air connection (not illustrated) can be affected by compressed air in different ways from one another and thus hardness of the chambers is adjustable. Thus, for example, elastic behavior of the stator 205 can be freely adjusted within broad boundaries. For example, stepwise-increasing hardness of the stator 205 can be adjusted in such a way as to counteract increasing pressure in the eccentric screw pump 201 along the conveying direction 281.

1. A stator for a pump, in particular for a rotary piston pump or an eccentric screw pump, having a base body, wherein the base body surrounds a pumping area for a rotor arrangement, the pump, comprising a support body and a running body, said running body configures a running surface for at least partial contact with the rotor arrangement of the pump, said support body and the running body include a common material where a material density of the material of the support body and a material density of the material of the running body are configured differently from one another, so that a different elasticity and/or a different hardness of the material in the support body and in the running body is achieved by means of the differently configured material densities.

2. The stator according to claim 1, characterized in that the material density of the running body is greater than the material density of the support body, so that the running body in particular has a lower degree of elasticity and/or a higher degree of hardness than the support body.

3. The stator according to claim 1, characterized in that the support body comprises a first support body part, a second support body part, a third support body part and/or an additional support body part, wherein the material densities of the material of the respective support body part are configured differently from one another, so that by means of the differently configured material densities a different elasticity and/or a different hardness of the material in the respective support body part is achieved compared to the respective other support body part, wherein in particular the respective support body parts are arranged in layers situated primarily radially around the pumping area.

4. The stator according to claim 1, characterized in that the support body and/or in particular the respective support body part comprises or include an inner structure, wherein the inner structure includes pores, cavities and/or chambers as well as webs, lamellae and/or material bridges, wherein a different elasticity and/or a different hardness of the material is achieved in the support body and in the running body, in particular by means of the macroscopic material densities configured by a distribution of the pores, cavities and/or chambers as well as webs, lamellae and/or material bridges.

5. The stator according to claim 4, characterized in that the inner structure is configured to be accessible through fluid conducting, by means of one or more pressure fluid supply lines, wherein by introducing a pressure fluid through the pressure fluid supply line or lines into the pores, cavities and/or chambers of the inner structure a pressure-generated force on the running body is increased and/or reduced by releasing a pressure fluid through the pressure fluid supply line or fluid supply lines from the pores, cavities and/or chambers of the inner structure.

6. The stator according to claim 5, characterized in that the pressure fluid supply line or lines are associated with a control device for controlling the introduction and/or release of the pressure fluid through the pressure fluid supply line.

7. The stator according to claim 1, characterized in that the support body and/or in particular the respective support body part and/or the running body is manufactured by means of a material-shaping primary forming process, in particular by means of an additive process and/or by means of a sintering process.

8. The stator according to claim 1, characterized in that the common material comprises an additional material, wherein in particular the different material density is additionally changed by means of a respective proportion of the additional material in the support body, in the respective support body part and/or in the running body.

9. The stator according to claim 1, characterized in that the common material comprises a plastic, in particular an elastomer, a duroplast and/or a thermoplast and/or a metal, in particular a steel, an aluminum and/or a titanium.

10. A method for producing a stator for a pump, in particular for a rotary piston pump or an eccentric screw pump, having a base body, wherein the base body surrounds a pumping area for a rotor arrangement of the pump, the pump having a support body and a running body, and the running body configures a running surface for at least partial contact with the rotor arrangement of the pump, the support body and the running body includes a common material and in that a material density of the material of the support body and a material density of the material of the running body are configured differently from one another, so that a different elasticity and/or a different hardness of the material in the support body and in the running body is achieved by means of the differently configured material densities., wherein the stator comprises a base body having a support body and a running body, the base body surrounds a pumping area for a rotor of the pump, and the running body configures a running surface for at least partial contact with the rotor of the pump, wherein the base body includes material densities differing from one another, wherein the method comprises the following steps:
introducing a material basic material into a production space so that the material basic material is present in the production space,
treating the material basic material in the production space, wherein the material basic material is converted into a common material by means of the treatment and wherein the treatment is conducted differently for a first production area for producing the support body from the treatment for a second production area for producing the running body, in such a way that a material density of the material of the support body and a material density of the material of the running body are configured differently from one another,
so that the stator is manufactured in such a way that a different elasticity and/or a different hardness of the material in the support body and in the running body are achieved by means of the differently adjusted material densities.

11. The method according to claim 10, characterized in that the treatment comprises a material-forming primary shaping method, in particular an additive method and/or a sintering method, wherein the treatment takes place in particular in a common manufacturing process by an adjustment of the respective manufacturing parameters.

12. A stator for a pump, in particular for a rotary piston pump or an eccentric screw pump, having a base body, wherein the base body surrounds a pumping area for a rotor arrangement of the pump, a support body and a running body, and the running body configures a running surface for at least partial contact with the rotor arrangement of the pump, the support body and the running body includes a common material and in that a material density of the material of the support body and a material density of the material of the running body are configured differently from one another, so that a different elasticity and/or a different hardness of the material in the support body and in the running body is achieved by means of the differently configured material densities, which is produced by a material-forming primary shaping method, in particular an additive method and/or a sintering method, wherein the treatment takes place in a common manufacturing process by an adjustment of respective manufacturing parameters.

13. The stator according to claim 2, characterized in that the support body comprises a first support body part, a second support body part, a third support body part and/or an additional support body part, wherein the material densities of the material of the respective support body part are configured differently from one another, so that by means of the differently configured material densities a different elasticity and/or a different hardness of the material in the respective support body part is achieved compared to the respective other support body part, wherein in particular the respective support body parts are arranged in layers situated primarily radially around the pumping area.

14. The stator according to claim 2, characterized in that the support body and/or in particular the respective support body part comprises or include an inner structure, wherein the inner structure includes pores, cavities and/or chambers as well as webs, lamellae and/or material bridges, wherein a different elasticity and/or a different hardness of the material is achieved in the support body and in the running body, in particular by means of the macroscopic material densities configured by a distribution of the pores, cavities and/or chambers as well as webs, lamellae and/or material bridges.

15. The stator according to claim 2, characterized in that the support body and/or in particular the respective support body part and/or the running body is manufactured by means of a material-shaping primary forming process, in particular by means of an additive process and/or by means of a sintering process.

16. The stator according to claim 2, characterized in that the common material comprises an additional material, wherein in particular the different material density is additionally changed by means of a respective proportion of the additional material in the support body, in the respective support body part and/or in the running body.

17. The stator according to claim 2, characterized in that the common material comprises a plastic, in particular an elastomer, a duroplast and/or a thermoplast and/or a metal, in particular a steel, an aluminum and/or a titanium.
